(19) United States
(12) Patent Application Publication
(10) Pub. No.: US 2006/0249249 A1
(43) Pub. Date: Nov. 9, 2006

(54) Method and apparatus for applying tape patterns

(75) Inventors: Stephen M. Bills, Cuyahoga Falls, OH (US); William A. Briese, Hinckley, OH (US)

Correspondence Address: WATTS HOFFMANN CO. L.P.A., 1100 SUPERIOR AVE., SUITE 1750, CLEVELAND, OH, 44114, US

(73) Assignee: GED Integrated Solutions, Inc.

(21) Appl. No.: 11/121,603

(22) Filed: May 4, 2005

(51) Int. Cl. B32B 38/04; B32B 37/00; B32B 37/12

(52) U.S. Cl. 156/265; 156/250; 156/267; 156/299; 156/353; 156/361; 156/523; 156/526

(57) ABSTRACT

Apparatus and process that applies multiple tape segments onto a window or door panel by identifying tape segments to be applied to a panel in a pattern. The pattern is achieved by moving a tape dispensing head with respect to the panel while applying a first set of multiple tape segments from the application head as the application head is moved with respect to the panel. The tape segments of the first set are trimmed after they are dispensed onto the panel. The tape dispensing head is then moved with respect to the panel while applying a second set of multiple tape segments. To produce the desired pattern one or more of the multiple tape segments from the second set are in close proximity to one or more tape segments from the first set. The one or more of the multiple tape segments of the second set are trimmed after they applied to the panel without cutting into the tape segments of the first set.

### FIELD OF THE INVENTION

The present invention relates to a method and apparatus for applying decorative tape patterns to window panels and, more particularly, the present invention relates to a method and apparatus for applying aligned decorative patterns in overlying relations to make the patterns more attractive.

### BACKGROUND

Various types of tape have been developed that have a decorative appearance when applied to glass. For example, U.S. Pat. No. 4,192,905 to Scheibal describes a transparent strip of polymeric material used to imitate a beveled edge. The transparent strip has a wedge-shaped cross-section having an angle similar to a beveled edge. The transparent strip has adhesive on one side for affixing the strip to the glass to produce a beveled edge appearance. U.S. Pat. No. 5,840,407 to Futhey et al. describes an optical film for simulating beveled glass. The optical film has a structured surface for providing a simulated beveled appearance. The structured surface is formed of a plurality of spaced parallel grooves that form a plurality of facets that simulate beveled glass.

Various applicators have been developed for applying tape to a surface. For example, U.S. Pat. No. 6,571,849 to Erickson et al. discloses a tape applicator that includes a tape head having a base, a tape roll holder attached to the base and a tape application roller for applying a tape to a surface attached to said base, where the tape applicator includes a tape path from the tape roll holder to the tape application roller. The tape applicator includes a x-axis actuator operatively connected to the tape head for moving the tape applicator in the x-axis direction and a y-axis actuator operatively connected to the tape head for moving the tape applicator in the y-axis direction.

United States published application 2003/0109946 entitled “Computer-Aided Layout and Application of Tape” assigned to 3M Innovative Properties Company relates to techniques that enable conventional computer-aided design software applications to be used to precisely control application of tape to a surface such as a glass surface. The subject matter of this patent is incorporated herein by reference.

FIG. 9 of this patent application discusses a process of using computer aided design layout in the laying of tape onto a surface. To create a pattern of tape segments for application by an automated tape applying head, the user graphically places design objects such as tape centerlines and dashed lines to designate cut lines within a two dimensional space. A translator accesses tape data and cut data for the design or pattern and generates instructions for controlling a tape applicator. A computer communicates these instructions to the tape application which applies tape to the article. See page 3 paragraph 39 and 40 of the published application to 3M.

At paragraph 61, the 3M published application states “After identifying the set of segments, translation module 10 generates instructions 5 directing tape applicator 6 to apply tape along each path (162, 164). During the application of each segment, . . . tape applicator 6 performs all corresponding cuts intersecting the tape segment. By selecting non-intersecting tape segments, tape translation module 10 ensures that applicator 6 will not apply a tape segment on top of another tape segment. After applying and cutting the non-intersecting tape segments, translation module 10 generates instructions 5 directing tape applicator 6 to pause for manual removal of scrap tape portions that have been cut from the tape segments (165). In this manner, tape applicator 6 allows for removal of a scrap portion from a tape segment prior to applying an intersecting tape segment. Translation module 10 continues the process until traversing all of tape data 11, i.e., until instructions have been completed for forming the entire pattern (166).”

### SUMMARY

The above quoted section of the published 3M application address a concern that scrap pieces are not left on the sheet and covered by intersecting tape segments before those scrap pieces can be removed. The present invention concerns a method and apparatus for applying decorative tape patterns to a panel to enhance the appearance of the resulting pattern and avoid cutting into already applied tape as a tape dispensing head cuts other tape segments.

An exemplary process applies multiple tape segments onto a window or door panel by identifying tape segments to be applied to a panel in a pattern. The pattern is achieved by moving a tape dispensing head with respect to the panel while applying a first set of multiple tape segments from the application head as the application head is moved with respect to the panel. The tape segments of the first set are trimmed after they are dispensed onto the panel. The tape dispensing head is then moved with respect to the panel while applying a second set of multiple tape segments. To produce the desired pattern one or more of the multiple tape segments from the second set are in close proximity to one or more tape segments from the first set. The one or more tape segments of the second set are trimmed after they applied to the panel without cutting into the tape segments of the first set.

These and other features of the invention will become better understood by reference to the accompanying detailed description which is described in conjunction with the accompanying drawings.

### BRIEF DESCRIPTION OF THE DRAWINGS

FIG. 1 is a perspective view of a tape segment application station constructed in accordance with the invention;

FIG. 2 is an enlarged perspective view of the FIG. 1 application station showing details of a tape application head;

FIGS. 3 and 4 are schematic enlarged elevation view of the tape application head showing operation of a cutter for cutting elongated tape segments;

FIG. 5 is a perspective view of the application head from a different view;

FIGS. 6-8 illustrate representative tape patterns applied to a surface such as a window surface;

FIGS. 6A and 7A are enlarged depictions showing a closeup of regions of the patterns where tape segments are in close proximity or overlapping configurations;

FIGS. 9 and 10 illustrate enlarged views of tape segments used in discussing problems with cutting or appearance of tape segments; and

FIG. 11 is an overview flow chart showing a process of the invention.

### DETAILED DESCRIPTION

The present disclosure is directed to patterns 10 of decorative tape applied to panels 12, such as glass sheets that that are cut to form window lites. A tape head 100 dispenses decorative ductile tape segments onto the panels to make up those patterns and a controller coordinates movement of the tape head as the tape is dispensed by the tape head.

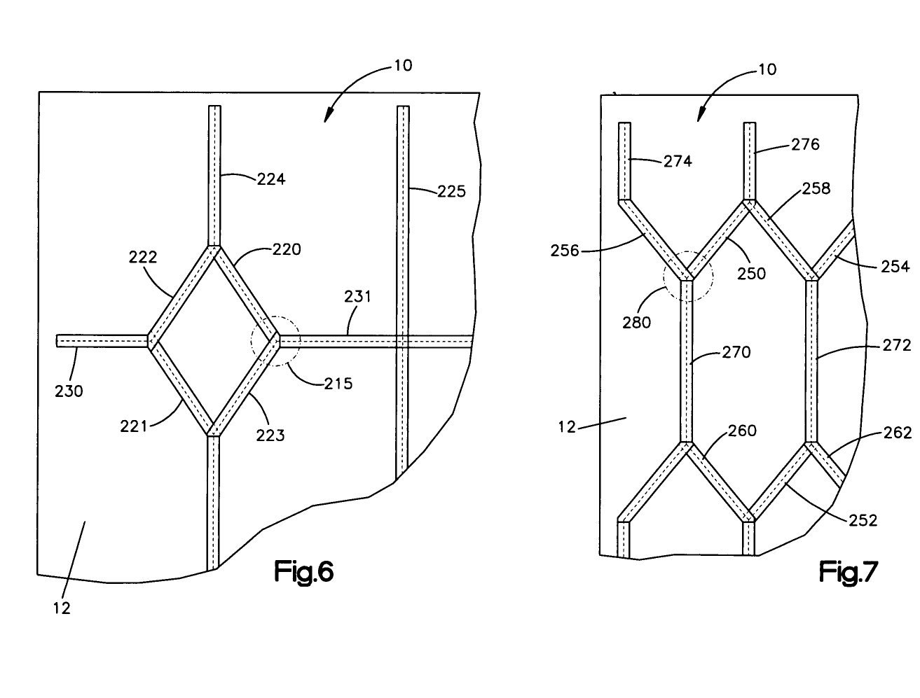

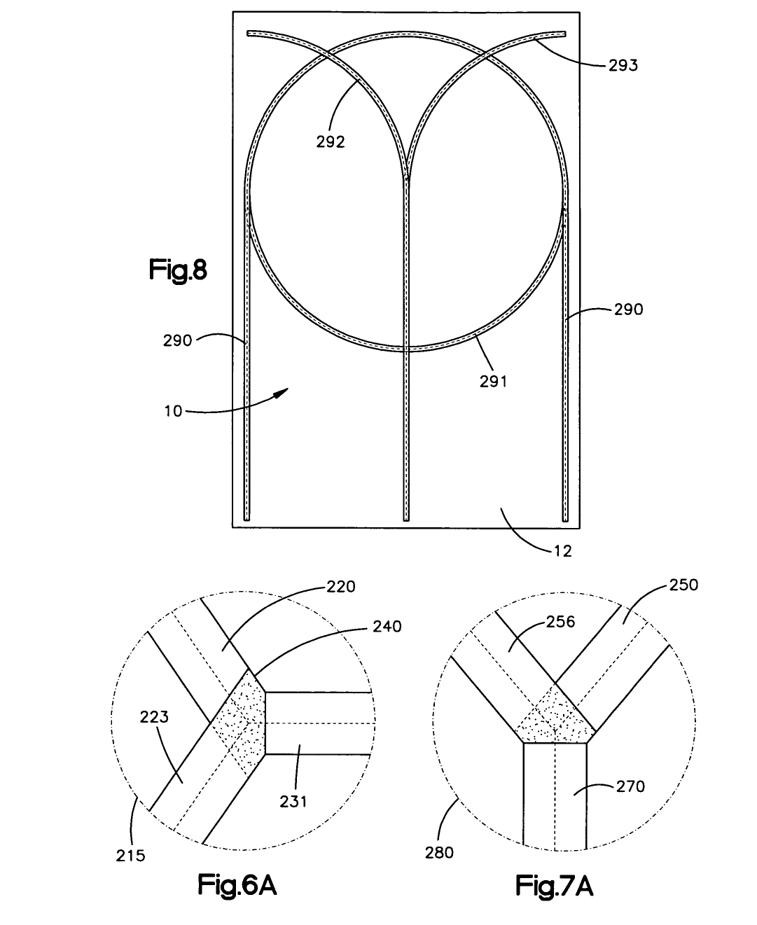

FIGS. 6-8 illustrate decorative or ornamental tape patterns 10 or configurations applied to a glass sheet 12. The decorative patterns illustrated by these Figures may be a lead strip with an adhesive backing or may be a tape that provides the appearance of lead when applied to the glass sheet 12. Small application tolerances created during the application of any of the tape strips as well as selective trimming of the tape reduces the likelihood of visible gaps between two different strips or segments of the tape.

Lead tape used to make up the patterns 10 is very ductile. In some respects, it is more difficult to apply such lead tape and then cut to a specified shape than more stiff tapes, such as ACCENTRIM™ tape. For example, bends in the lead tape that occur as the lead tape travels through the tape head tend to be retained when the tape is applied to the glass sheet. The blades of traditional cutoff tools included in tape dispensing heads are spread apart by the thicker, ductile lead tape. The ductile property of lead tape also makes it possible to apply curved patterns to the glass sheet. The tape head 100 includes features that allow smooth lengths of ductile tape 22 to be applied, that facilitate cutting of thicker, ductile tape and/or that allow curved segments of ductile tape 22 to be applied to glass sheets 12.

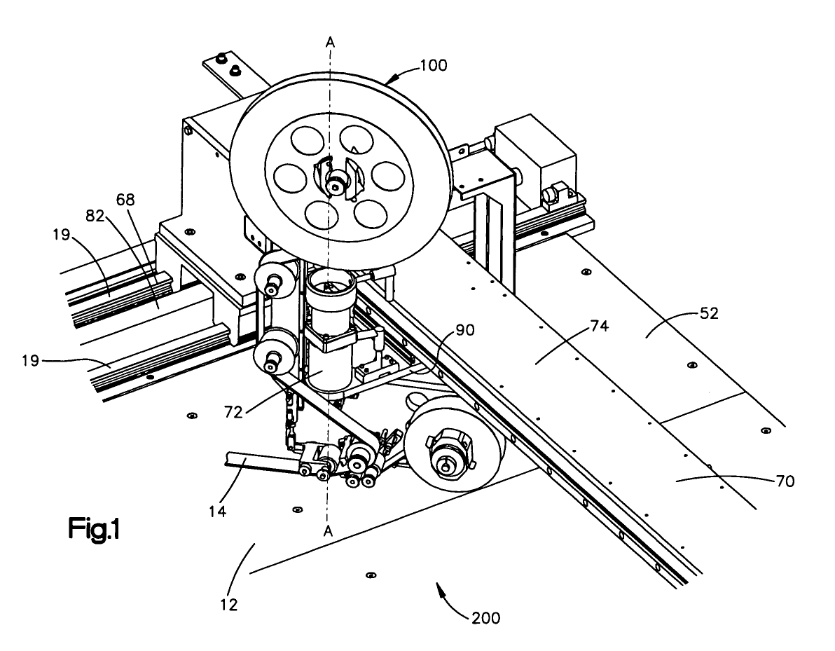

An exemplary tape applicator station 200 (FIG. 1) includes the moveable tape head 100 and a tabletop 52 for supporting a glass sheet or other panel. With the use of actuators, the tape head 100 moves to different locations relative to the tabletop 52 to apply tape to an article on the tabletop 52, such as a sheet of glass 12. The tape head 100 applies lengths of tape to a sheet of glass 12 to create decorative patterns. The tape applicator station is especially useful for applying decorative tape including lead tape that simulates the appearance leaded glass. A similar tape head can apply optical film that simulates an etched, grooved, or beveled appearance. One such optical film is described in U.S. Pat. No. 5,840,407. The tapes disclosed in U.S. Pat. No. 5,840,407 are commercially available as 3M, Accentrim™ Tape, from 3M Company, located in St. Paul, Minn. These tapes are referred to herein as ACCENTRIM™ tapes.

The tape applicator station preferably includes a frame for holding the tabletop 52. The tabletop 52 is preferably tilted to allow a user to easily place a sheet of glass 12 on the tabletop 52. Tape patterns 10 are applied to opposite sides of the glass sheet if needed. The tabletop 52 may optionally include a vacuum system for holding the sheet of glass stationary on the tabletop 52. The tabletop 52 and frame are sized to handle desired sizes of glass.

The tabletop 52 defines an x-axis and an y-axis in the plane of the tabletop and a z-axis perpendicular to the tabletop 52. The station 200 includes a x-axis actuator 68, a y-axis actuator 70 and a z-axis actuator 72 for supporting, moving, and positioning the tape head 100 at different locations on the tabletop 52. The y-axis actuator 70 includes a support arm 74 that extends in the y-axis direction of the tabletop 52. The y-axis actuator 70 is moved in the x-axis direction by the x-axis actuator 68. The y-axis actuator 70 moves the tape head 100 in the y-axis direction of the tabletop 52 along the support arm 74.

FIG. 1 illustrates the tape head 100 applying decorative tape 14 to the sheet of glass 12 as the tape head 100 moves. To move the tape head 100 along the x-axis of the tabletop 52, the support arm 74 is moved by the x-axis actuator. To move the tape head 100 along the y-axis of the tabletop 52, the tape head moves along the support arm 74. The tape head 100 may move to a first location on the tabletop 52, start applying tape to the sheet of glass 12. The tape head 100 continues applying tape to the sheet of glass 12, as it moves to a second location on the tabletop 52.

The rotary actuator 72 for rotating the tape head 100 around an axis A that is parallel to the z-axis. Any commercially available rotary actuator may be used. An example of a suitable step motor is sold under the trade name Compumotor, which is commercially available from Braas Company located in St. Paul, Minn., sold under the part number S83*135-MO-S. FIG. 10 illustrates the rotary actuator 72 rotating the tape head 100 about an axis of rotation A. The rotary actuator 72 is mounted to the car 90. The rotary actuator rotates the tape head 100 around the z-axis of the tabletop 52. As the rotary actuator 72 turns, the tape head 100 turns about axis A.

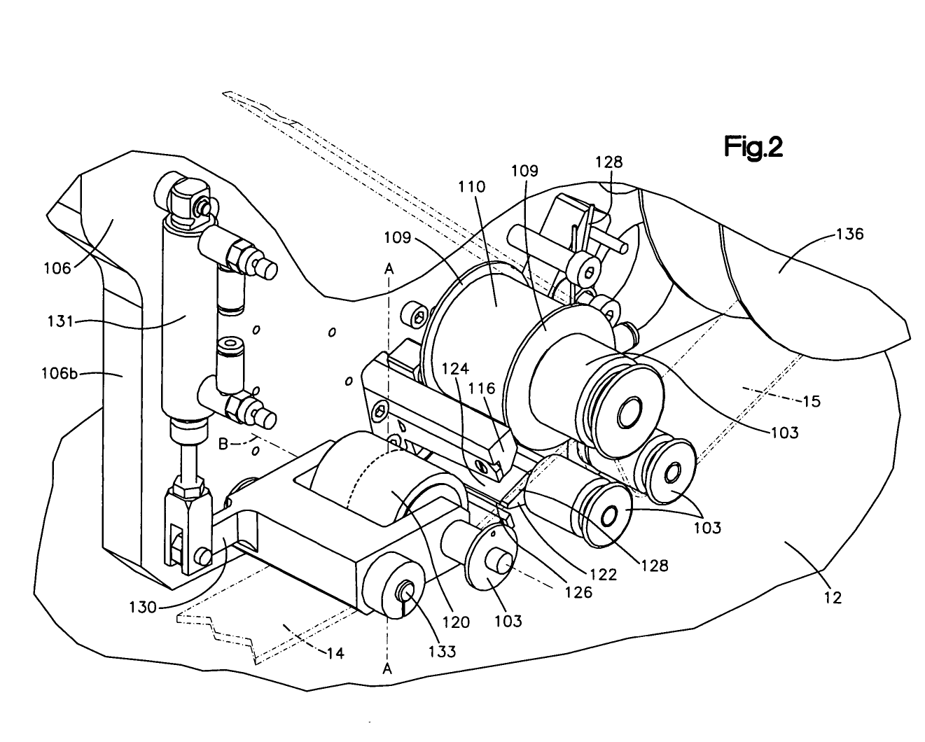

The tape head 100 is illustrated in FIGS. 2-5. The tape head 100 first begins applying tape to the sheet of glass 12 and then as the tape is being applied, the tape head cuts the tape with a cutting mechanism 116 to form the end of a first length of tape. The end of the first length of tape is then applied to the surface by the tape head.

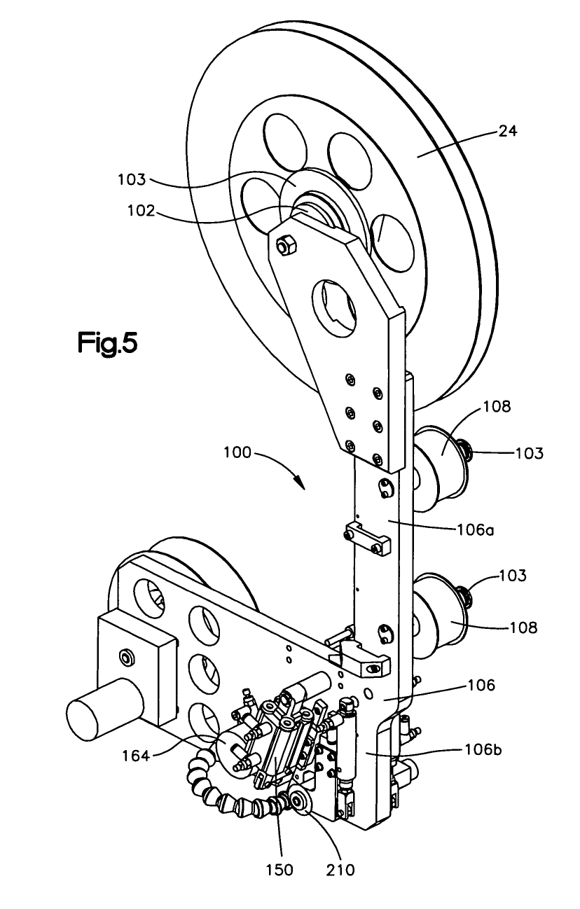

FIG. 5 illustrates one side of the tape head 100. The rotary actuator 72 for rotating the tape head about axis A has been removed for clarity. The tape head 100 includes a base 106. Preferably, the base 106 includes an upper base arm 106a and a lower base portion 106b. The tape head 100 includes a tape roll holder 102 and tape guide rollers 108 attached to the upper base arm 106a. The tape roll holder 102 is for receiving a roll of tape 24. The tape roll holder 102 preferably includes a friction clutch 103 to provide back tension on the tape 14 as it unwinds from the tape roll 24, so the tape does not continue to unwind from the roll 24 when the tape head 100 stops applying tape to the surface. The tape rolls are easily mounted to the tape roll holder using a quick connect collar 103. The quick connect collar 103 and spacer rings allow the tape roll to be changed without a tool.

As seen in the depiction of FIG. 2, the tape head 100 also includes a drive roller 110, a pinch roller 118, a pivotal platen 122, the cutting mechanism 116, an application roller 120, and a liner take-up roller 136, all attached to the lower base portion 106b. In the exemplary embodiment, the guide rollers 108, 110, the drive roller 110, the pinch roller 118, the pivotal platen 122, the application roller 120, and the liner take-up roller 136 are all mounted using a quick connect collars 103. The quick connect collars 103 allow different sizes and types of tape 14 to be easily mounted and removed from the tape head 100.

The cutting mechanism 116 includes a fixed blade 112 and a moveable blade 114 that is restricted to linear movement with respect to the fixed blade. The application roller 120 is mounted to the lower base portion 106b. Referring to FIG. 12, the tape head 100 includes an application roller air cylinder 131 for pivoting a bracket 130 about a pivot to place the application roller 120 in contact with the tape 14 and the glass sheet 12.

In the exemplary embodiment, the tape 14 moves along the following tape head path:

1) from the tape roll holder 102 to the guide rollers 108;

2) then to the nip formed between the drive roller 110 and the pinch roller 118;

3) then to the pivotal platen 122 and over the platen;

4) then between the blades 112, 114 of the cutting mechanism 116, which are spread apart;

5) then under the application roller 120, which applies the tape 14 to the glass sheet 12.

In one embodiment, the tape head 100 is configured to minimize bending of the tape 14 along the path of travel between the drive roller 110 and the tape application roller. This reduces visible defects in the ductile tape, such as lead tape, applied to the glass surface. Lead tape has a high degree of bend memory. That is, when lead tape is bent it tends to stay bent. Bends retained in the lead tape produce visual defects. In this embodiment, the drive roller 110, the pinch roller 118, the pivotal platen 122 and/or the application roller 120 are configured to minimize bending of the tape between the drive roller 110 and the application roller 120.

The pivotal platen 122 separates the liner 15 from the tape 14, as the tape 14 passes over the platen 122. After the liner 15 is separated from the rest of the tape 14, the liner winds around the pinch roller 118 and is taken up by the liner roller 136 (see FIG. 18). The liner 15 is separated from the rest of the tape 14 at the end of the pivotal platen 122. The liner is then wound around the pinch roller 118 and wound around the liner roller 136.

FIG. 2 illustrates a partial isometric view of the lower portion of the base 106b. The tape 14 winds around the drive roller 110 between two opposite tape guides 109. The tape guides 109 assist in keeping the tape 14 straight or from slipping off of the drive roller. The tape 14 then passes over the pivotal platen 122 along the guide surface 124. The guide surface 124 includes two opposite tape guides 128. The tape guides 128 also assist in keeping the tape 14 straight just prior to its application to the glass sheet by the application roller 120. The liner 15 is separated from the rest of the tape 14 at the edge 126 of the guide surface 124. The edge 126 of the guide surface 124 is preferably sharp to assist in separating the liner 15 from the rest of the tape 14. The guide surface 124 of the pivotal platen 122 is positioned to direct the tape 14 over the fixed blade 112 of the cutting mechanism 116. The moveable blade 114 is biased away from the fixed blade 112 to allow the tape to pass between the blades 112, 114 of the cutting mechanism 116. The tape is then applied to the glass sheet by the application roller 120.

FIG. 5 illustrates the second side of the tape head 100, which is opposite the side of the tape head 100 illustrated in FIG. 11. The tape head 100 includes a rotary servo motor 164 mounted to the lower base portion 106b for driving the drive roller 110. The tape head also includes an air cylinder 150 attached to the lower base portion 106b for actuating the moveable blade 114 in the cutting mechanism 116.

The tape 14 includes an adhesive layer 28 and a liner 15 covering the adhesive layer. Examples of tape that can be applied by the disclosed tape head 100 are ACCENTRIM™ tape and lead tape. To start applying the tape to the surface, the tape end 95 is located under the application roller 120. The application roller air cylinder 131 actuates the application roller 120 into contact with the tape 14 and the glass sheet 12. Once the tape 14 is between the application roller 120 and the sheet 12, the adhesive layer bonds the tape 14 to the glass sheet by pressure. These steps are used to initially start applying the first end 95 of the tape 14 to the sheet of glass 12. To continue applying tape 14 to the glass sheet 12, the tape head 100 moves relative to the stationary sheet of glass 12, while the application roller 120 applies the tape 14.

In one embodiment, the tape head 100 is adapted for applying a lead tape 14 having a curved profile to a glass surface. In this embodiment, tape head 100 includes a tape application roller having a circumferential concavity that corresponds to the curved tape profile for pressing the tape to the glass surface. The concavity can be slightly over-cupped as compared to the tape profile to apply more pressure to edges of the curved tape than a central portion of the curved tape. The tape application roller having a circumferential concavity smooths out rippled edges of a tape strip, such as a lead tape strip, and also seals the edges from water penetration.

In one embodiment, the tape head 100 is adapted to apply curved patterns 183 of ductile tape to glass sheets. Referring to FIG. 2, in this embodiment, the tape application roller 120 is centered on the axis A of rotation of the tape head 100 such that the tape application roller 120 rotates about its midpoint when the tape head rotates. That is, the axis A intersects the axis B of the tape application roller 120 at the midpoint M of the Tape application roller. Centering the application roller with the axis of rotation A of the tape head permits arced ductile tape segments to be applied without a “caster” effect from creating undesired offsets from the intended arc.

In one embodiment, curved tape segment patterns that are stored in a controller 200 having a memory are automatically applied to a glass surface. The tape head is moved along a path stored in a controller memory. The controller 200 controls the tape head to dispense curved patterns of tape onto the glass surface. This is facilitated by aligning the midpoint of a tape application roller carried by the tape head with an axis of rotation of the tape head.

In the exemplary embodiment, the cutting mechanism is adapted to cut a thick, ductile tape, such as a tape that provides the appearance of leaded glass when applied. The cutting mechanism 116 includes the fixed blade 112, a first linear bearing component 131, a second linear bearing component 133, the linearly moveable blade 114, and the blade actuator 150. In the illustrated embodiment, the a stationary blade 112 is coupled to the frame by a stationary blade bracket 135. The first linear bearing component 131 is also coupled to the frame. The second linear bearing component 133 is coupled to the first linear bearing component 131 such that the second linear bearing component is constrained to linear movement with respect to the first linear bearing component. The moveable blade 114 is connected to the second linear bearing component by a moveable blade bracket 139. The moveable blade 114 is constrained to linear movement with respect to the fixed blade 112. The actuator 150 is coupled to the moveable blade 112 and the frame 114 for moving the moveable blade along a linear path with respect to the fixed blade to cut the lead tape. In the illustrated embodiment, a backing member 141 fixed to the frame is positioned behind the moveable blade bracket 139 to prevent movement of the moveable blade away from the fixed blade. The cutting mechanism provides sufficient clearance and support for wide lead tape strips, such as 18 mm wide lead tape, and allows for easier blade gap setting. The linear bearing arrangement helps maintain alignment of the blade while maintaining the rigidity of the bladeholders.

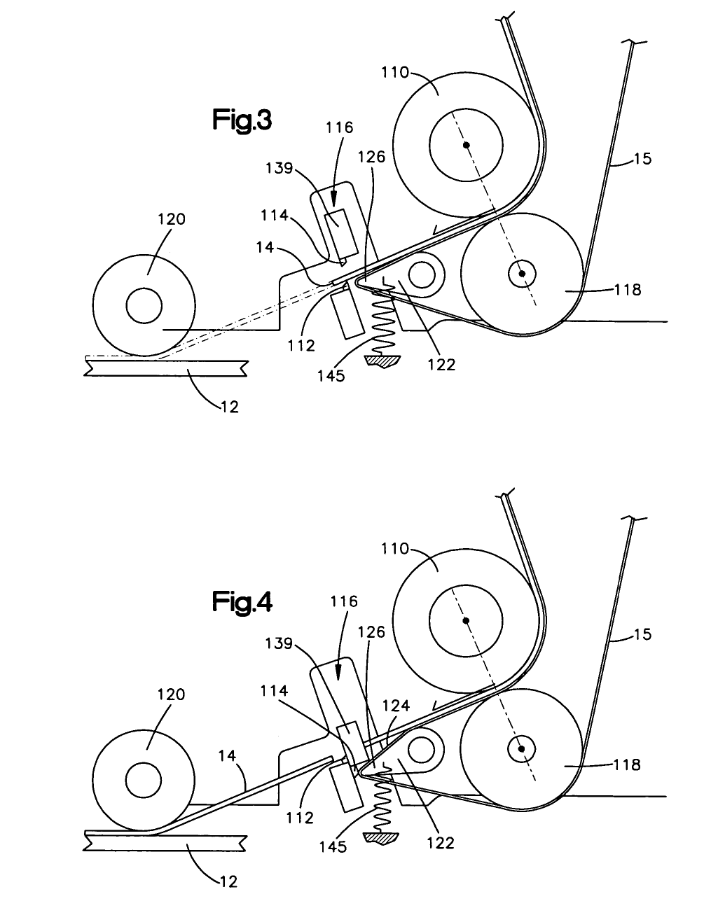

The cutting mechanism 116 cuts the tape 14 transversely when the air cylinder 150 actuates to force the moveable blade 114 to move along a linear path and contact the fixed blade 112. Referring to FIG. 3, the moveable an fixed blades are normally in a spaced apart relationship. A biasing spring 145 biases the pivotable platen 122 to the position illustrated in FIG. 16A. Referring to FIG. 4, as the moveable blade 114 moves to contact the fixed blade 112, the pivotal platen 122 is pushed counter clockwise by the moveable blade bracket 139 against the force of a biasing spring 145 to move the guide surface 124 away from the blades 114, 116 of the cutting mechanism 116.

To apply the second end 151 of the tape 14, the tape head 100 continues moving relative to the sheet of glass to allow the application roller 120 to press the remaining tape 14 against the glass sheet 12. The air cylinder 150 moves the moveable blade 114 again to move the moveable blade 114 out of contact with the fixed blade 112. At the same time the moveable blade 114 moves out of contact with the fixed blade 112, the pivotal platen 122 rotates clockwise under the force of the biasing spring to move the platen toward the blades 114, 116 of the cutting mechanism 116, between the blades 114, 116 to allow the tape 14 to pass through the cutting mechanism 120 when the tape advances.

To operate the x-axis actuator 68, y-axis actuator 70, and rotary actuator 72 to move the tape head 100, the station 200 preferably includes a computer processor/controller 300 for sending signals to the actuators 68, 70, 72 to move the tape head 100 relative to the tabletop 52. The computer processor and controller then determines which way to direct the actuators 68, 70, 72 to move the tape head 100 to apply the tape to the glass and to cut the tape. In one embodiment, the computer processor and controller is an “open loop” system, which calculates where the tape head 100 is located on the tabletop 52, based on a known series of moves. For example, the ball screw in either the x-axis actuator 68 or y-axis actuator 70 will move the tape head 100 a known distance per one rotation of the ball screw. If the computer processor knows the initial location of the tape head 100, like the first home position, or the second home position, it can determine the final location of the tape head 100, based on how many rotations the ball screws actually rotated. The computer processor will send a signal to the x-axis and y-axis actuators 68, 70 to turn the ball screws a calculated number of rotations to move the tape head 100 a certain distance in a given direction. The computer processor also sends signals to the rotary actuator 72 to rotate the tape head 100 relative to the z-axis of the tabletop 52. A suitable controller 300 is a controller sold under the trade name Compumotor, which is commercially available from Braas Company located in St. Paul, Minn., sold under part number 6K4. In another embodiment, the computer processor is a “closed loop” system, which calculates where the tape head 100 is at all times on the tabletop 52.

In the exemplary embodiment, the controller is programmed for quick tooling changes. The changeover from one size or type of tape is done with quick release collars. A software offset library is stored in a memory of the controller. The software offset library retains settings that are specific to the set of parts (guide rollers, drive roller, pinch roller, platen, application roller) that correspond to each size/type of tape. As a result, it is not necessary to mechanically alter one set of parts to respond similarly to other sets of parts. The software offset library is used to adjust the application settings of the head 110, to apply different sizes/types of tape in a similar fashion. The controller is also programmed to allow one set of parts to operate in more than one way. For example, the controller is programmed to use the same set of parts to apply a straight tape strip and a curved tape strip.

To determine the initial location of the tape head 100 on the tabletop 52, the actuators 68, 70, 72 preferably include sensors to determine the location. Suitable sensors for the actuators 68, 70, 72 are Prox Sensors sold under the trade name Omron, which is commercially available from Braas Company located in St. Paul, Minn., sold under part number E2E-X1R5E1-M1-N.

In one embodiment, the tape applicator head 100 is coupled to a controller 300 that is adapted to apply aligned decorative patterns 10 to both sides of a glass sheet 12. Applying lead tape strips to both sides of the glass requires that they are directly on top of each other so that the glass appears to have been actually leaded. An offset of the lead strip on the inside and outside surfaces will create a visual defect. If the same home position on the table is used as the reference point, a different corner of the glass sheet will be referenced when the glass sheet is flipped. If the glass size is different than the desired (programmed) size, an offset will occur between the inner and outer lead strips. As described in co-pending application Ser. No. 10/922,741 use of a second home position on the table so that the same corner on the glass sheet is referenced eliminates this chance of error.

Some tape segments are applied through use of the cutter 116 only. These are elongated tape segments with square ends achieved by cutting accross the width of the tape with the cutter to form a perpendicular cut completely through the tape. Other cuts are applied by a rotatably mounted wheel cutter 210 (piazza cutter) mounted to the head 100. This cutter rotates as the head 100 moves in relation to the glass to score the tape after it has been applied onto the surface of the glass. A typical tape application involves laying the tape and then going back to apply cuts with the cutter 210. Once this has been done, the excess tape is removed by an operator who removes the scrap tape segments from the glass.

Additional details regarding the tape application station 200 are contained in commonly assigned co-pending patent application Ser. No. 10/922,741 filed Aug. 20, 2004 entitled “Method and Apparatus for Applying Aligned Tape Patterns” whose subject matter is incorporated herein by reference.

Layering Tape Segments

The patterns 10 depicted in FIGS. 6-8 are representative of the types of elongated lead tape segments that can be laid onto a panel using the application head 100. Consider the pattern shown in FIG. 6, referred to in the window art as a Queen Anne or Queen Caroline pattern. The pattern 10 of FIG. 6 is a created by controlled movement of the application head 100 while laying down individual elongated tape segments that run in different directions and meet in regions of close proximity such as a region 215 that is shown in greater detail in FIG. 6A.

Of the tape segments shown in FIG. 6, the first two applied to the glass 12 are tape segments 220, 221. These are non-overlapping tape segments which extend generally parallel to each other. The next two segments to be applied are the segments 222, 223 which overlap portions of the two segments 220, 221 and complete a diamond shaped pattern. The next tape segments applied by the application head 100 are the three segments 224, 225, 226. Finally, the two segments 230, 231 are applied to the glass.

A few comments help explain the process of deciding an order of tape segment application. Generally all segments making up a first set that align in the same direction (are parallel to each other) are applied in sequence before other segments are applied that are aligned at oblique angles with respect to the first set. Hence, the two segments 220, 221 align and are applied as a set. Any overlying segments at oblique angles are also applied in a group. Note, that although the pattern 10 contains overlying segments, it is possible to cut tape after it is dispensed, so that the segments abut rather than overlie closely adjacent segment portions.

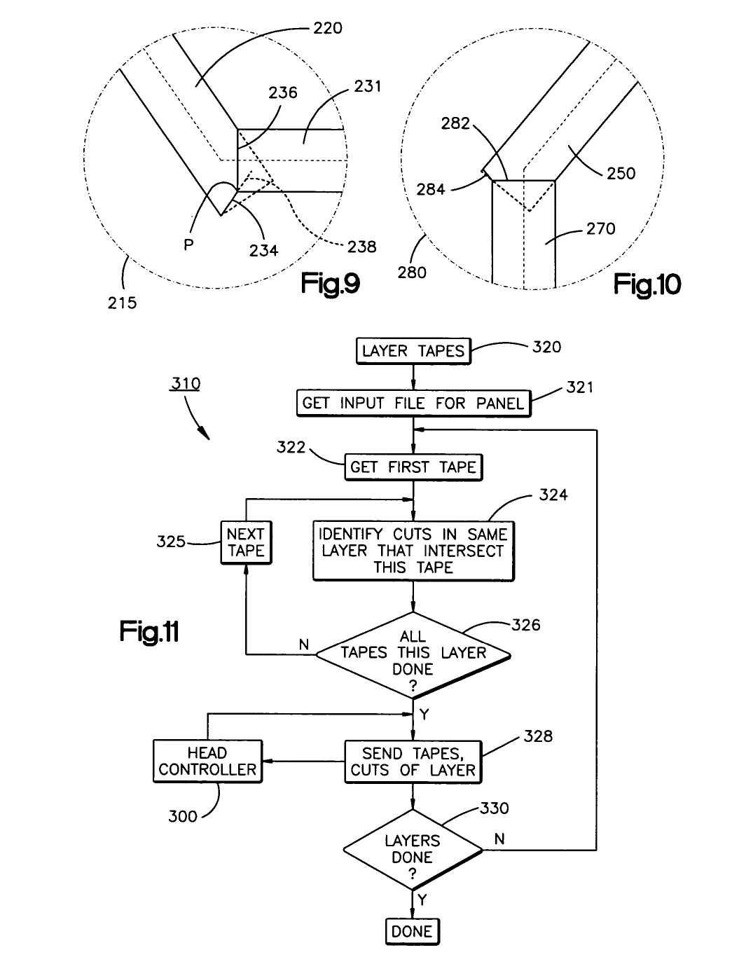

The enlarged view in FIG. 6A illustrates the region 215 where the three tape segments 220, 223, 231 are in close proximity to each other. The tape segment 223 overlies the tape segment 220 as indicated by the tipling on the drawing of FIG. 6A. Consider now the depiction in FIG. 9. The two tape segments 220, 231 are shown in the position and orientation as they appear in the pattern 10 of FIG. 6. Note, the segment 231 is cut at one end at a right angle by the blade 116. Two non-perpendicular cut lines 234, 236 are scored in the tape segment 220 by controlled movement of the pizza cutter 210 after the segment 220 is applied to the glass. One can reasonably ask which of the two tape segments should be applied first? Is there a preferred order? To properly cut the tape segments to achieve the best appearance, the tape segment 220 should be applied first. To show why, assume the tape segment 231 is applied first. If the tape segment 220 is applied after the tape segment 231, the segment 220 will overlie the perpendicular end of the segment 231 until the segment 220 is trimmed by means of the two cuts 234, 236. The scrap portion of the segment 220 is then manually removed. However, to implement the cut 234 the pizza cutter 210 must move beyond the endpoint P of the cut 234. This means that to adequately cut through the tape 220 in a way to allow the scrap to be removed, the cutter 120 must move beyond the end of the segment 234 along a path 238 that cuts into the endmost portion of the segment 231. The resulting pattern has a less than appealing appearance. If the tape segment 223 (FIG. 6A) is applied to the glass 12 after the piece 231 a similar displeasing cut will occur as a cut line 240 of the segment 223 is made.

FIG. 7 illustrates a Jacobean pattern on a glass sheet or panel made up of multiple tape segments. The first segments applied to the glass 12 to compose the FIG. 7 segments are tape segments 250, 252, 254. These are non-overlapping tape segments which extend generally parallel to each other. The next segments to be applied are the segments 256, 258, 260, 262 which overlap portions of the two segments 250, 252. Finally, the segments 270, 272, 274, 276 are applied.

The enlarged view in FIG. 7A illustrates a region 280 where the three tape segments 250, 256, 270 are in close proximity to each other. The tape segment 256 overlies the tape segment 250 as indicated by the stipling on the drawing of FIG. 7A. Consider now the depiction in FIG. 10. The two tape segments 250, 270 are shown in the position and orientation as they appear in the pattern 10 of FIG. 7. Note, the segment 270 is cut at one end at a right angle by the blade 116. One can reasonably ask which of the two tape segments 250, 270 should be applied first? Is there a preferred order? To properly cut the tape segments to achieve the best appearance, the tape segment 250 should be applied first.

To show why, assume the tape segment 270 is applied first. When the segment 250 is applied, it will overlie the end of the segment 270 as indicated by the dotted line region of overlap in FIG. 10. A trim cut 282 can be made to trim off the overlying portion of the tape segment 250. This trim cut 282 can extend along the perpendicular end of the segment 270. However, a small portion 284 of the tape segment 270 must be removed with a cut an an angle with respect to the cut 282 which will extend into the tape segment 250 and thereby leave a cut on the finished pattern that is less appealing.

A pattern 10 depicted in FIG. 8 is achieved by use of curved tape segments which are only possible due to the somewhat pliable nature of lead tape applied to the panel. The pattern of FIG. 8 is formed from tape segments 290, 291, 292, 293. It has been empirically determined by those familiar with more traditional stained glass window design, for example, that the order of application of these segments should be segment 291 first followed by segment 290, followed by segment 293, followed by segment 292. All of these segments have perpendicular cuts at both ends and it is due to the appearance of the pattern after the tape segments are applied that dictates the order of application.

The 2003/0109946 published application is not concerned with inappropriate cuts nor with controlling which segments overlie others in the finished pattern. It is only concerned with an ability to remove trimmed segments for pieces that lie beneath other pieces.

To overcome the problems encountered with cutting (or trimming) tape after it is laid onto the glass 12 as well as achieving a desired appearance, a concept of tape segment layering is used to define an order of tape application to the glass. Most modern computer aided design (CAD) software supports the concept of layers or layering. A drawing can have components made up of a number of named layers. By assigning tape segments to different layers and converting the layers to machine instruction language based on the order of the layers, it is guaranteed that subsets of tapes that make up the pattern are applied in a specific controlled order. Note, in accordance with an exemplary embodiment of the invention, the order of tape application within a layer is not important and is based on when the tape definition is encountered when the tape data is being interpreted by the controller 300. (See FIG. 11) Two examples of CAD programs that provide layering are Turbo-CAD and AutoCad. In accordance with an exemplary process of the invention, the layered autocad DXF drawings are created by sequentially evaluating a stored set of DXF drawings that have no layers. Stated another way the input to the process is a DXF file that contains a set of multiple tapes (solid lines) and cuts (dashed lines) and the output is a layered DXF file having tapes (solid lines) and cuts associated with those lines organized in layers for presentation to the controller 300 for interpretation by the controller.

A tape segment data structure for an elongated straight lead tape portion (such as depicted in FIGS. 6 and 7) is as defined in listing 1:

### Listing 1

'1) TapeXStart
'2) TapeYStart
'3) TapeTheta
'4) TapeXEnd
'5) TapeYEnd
'6) Tape extend amount due to cut angle at end of tape
'7) Tape extend amount due to cut angle at start of tape
'8) Pizza cutter down x, cut 1
'9) Pizza cutter down y, cut 1
'10) Cut endpoint 1 x
'11) Cut endpoint 1 y
'12) Cut endpoint 2 x
'13) Cut endpoint 2 y
'14) Cut theta
' . . . Repeat steps 7 through 13 for as many cuts on a piece

Data having this type structure is transferred in an order of application to the controller 300 by a formatting computer (not shown). The formatting computer may be a networked computer that is coupled to the hardware of the tape application station 200 and also executes, for example, a visual basic program that receives as input a dxf formatted drawing and produces a sequence of data structures such as the listing 1 data structure. The controller 300 responds to receipt of the data structure by moving the head 100 through co-ordinated motor energizations to an appropriate start position, applying a tape segment and performing any needed post application trimming.

If the dxf drawing is not layered, the formatting computer can produce layers but more typically the dxf drawing will be a layered drawing wherein tape segments are contained in layers based on a ‘correct’ order of application of the tape segments to the panel presently at the station 200.

A flow chart 310 of FIG. 11 illustrates the steps in controlling the head controller 200. A first step 320 is to layer tapes that are applied to a given panel or sheet that is positioned at the station 200. This is done either by a manual process wherein a user implements a layering based on a priori knowledge of what order is best to achieve a result or by a set of machine implemented rules relating to orientation and overlapping of tape segments. Once the tapes are layered 320, the flow chart 310 describes a process for assigning cuts to each tape of a pattern 10 that need trimming to format a tape in the manner of listing 1.

The drawing layers must be evaluated by the computer in a correct order. This order is evaluated 321 by the visual basic conversion program and as an example is done by an alphabetical ordering of the layer names. A first layer's first tape is identified 322 and all cuts for that tapes designated layer are identified 324 and added to the tape segment data structure (listing 1). That process continues by getting data 325 from other tape segments until it is determined 326 that all tapes in the first layer are formatted. If they have been formatted the process 310 transmits 238 the formatted tapes to the controller. Once all layers have been determined 330 to have been sent to the controller 300, the formatting computer institues a panel transfer away from the station 200 to a next station and loads tape data for the next subsequent panel or sheet that is delivered to the tape application station 200.

Although the present invention has been described with a degree of particularity, it is the intent that the invention include all modifications and alterations falling within the spirit or scope of the appended claims.

1. A method of applying multiple tape segments onto a window or door panel, comprising:
a) identifying tape segments to be applied to a panel to define a pattern of said tape segments on said glass pane;
b) moving a tape dispensing head with respect to the panel while applying a first set of multiple tape segments onto the panel;
c) trimming one or more of the multiple tape segments of the first set of multiple tape segments after applying said first set to the said panel;
d) moving said tape dispensing head with respect to the panel while applying a second set of multiple tape segments wherein one or more of said multiple tape segments in the second set is applied to the panel in close proximity to one or more tape segments from the first set; and
e) trimming one or more of the multiple tape segments of the second set of multiple tape segments after applying of said second set to the said panel without cutting into the tape segments of the first set.

2. The method of claim 1 wherein the first and second sets of tape segments are generally rectangular tape segments and wherein the applying of said generally rectangular tape segments to the glass pane comprises cutting the tape from an elongated tape dispensed from the dispensing head along a cut line generally perpendicular to said elongated tape to separate an endmost tape segment from the elongated tape.

3. The method of claim 1 wherein the elongated tape is pliable enough to be applied along an arcuate path and wherein the dispensing head moves a long an arcuate path as the tape is dispensed.

4. The method of claim 3 wherein the tape is constructed from a ductile material including a metal.

5. The method of claim 4 wherein the tape is lead tape.

6. The method of claim 1 wherein the trimming is performed by a rotary knife carried by said dispensing head after the tape segments are applied onto the panel.

7. The method of claim 1 wherein identifying the tape segments comprises evaluating a data store having a format that defines cut lines and tape dimensions for the tape segments and further comprising assigning each of said cuts to an appropriate one or more tape segments based on the position of the cut with respect to said pattern.

8. The method of claim 1 wherein each tape segment is trimmed, if necessary by the dispensing head prior to applying a next subsequent tape segment to the panel.

9. The method of claim 1 wherein identifying the tape segments comprises evaluating a data store having a format that defines cut lines and tape dimensions for the tape segments and further comprising assigning each of said cuts to a an appropriate set of tape segments based on the position of the cut with respect to said pattern and an orientation of the tape segment with which the cut is associated.

10. The method of claim 1 wherein the identifying comprises receiving a file of data representing elongated tape segments and trim cuts for those segments and generating a file of data organized in layers that define an order for applying tape segments to a panel based on membership in a given layer.

11. The method of claim 10 wherein the tape segments in the first and second sets are assigned to different drawing layers.

12. The method of claim 1 wherein one or more of the second set of tape segments overlie one or more tape segments from the first set.

13. The method of claim 1 wherein one or more of the second set of tape segments that are applied subsequently to those of the first set abut one or more tape segments in said first set.

14. The method of claim 1 wherein all tape segments in the first and second sets are categorized according to a direction of movement of the dispensing head as the tape segments of said sets are applied to said panel.

15. A method of applying multiple tape segments to a door or window panel, comprising:
a) advancing tape from a supply to a cutter and cutting the tape with a cutting implement to form tape segments and applying a first set of said tape segments to a panel along a first set of controlled paths;
b) trimming additional portions from the tape segment of said first set;
c) advancing tape from a supply to a cutter and cutting the tape with a cutting implement to form tape segments and applying a second set of said tape segments to a panel along a second set of controlled paths that intersect one or more of the first set of controlled paths; and
d) trimming additional portions from the tape segments of said second set.

16. The method of claim 15 wherein the tape segments that are pliable enough to be applied along arcs and additionally wherein at least some of the controlled paths are arcuate paths.

17. The method of claim 15 wherein the tape segments are malleable metal tape segments.

18. The method of claim 15 additionally comprising receiving a file of data representing elongated tape segments and trim cuts for those elongated trim segments and generating a file of data organized in layers that define an order for applying tape segments by an application head to a panel based on membership in a given layer.

19. The method of claim 15 wherein all tape segments in the first and second sets of tape segments are categorized according to a direction of the first and second set of controlled paths during application of the tape segments.

20. A system for applying multiple tape segments to a door or window panel, comprising:
a) an application head that applies tape segments to the panel;
b) a tape supply carried by the application head;
c) a drive roller that advances tape dispensed by the application head;
d) a cutter that defines end portions of each tape segment;
e) a controller programmed to:
i) identify multiple tape segments to be applied to the panel;
ii) identify an orientation of each tape segment on the panel; and
iii) classify each tape segments into first and second different sets based on the orientation and to control movement of said application head to first apply tape segments to the panel from the first set and then subsequently to apply tape segments from the second set to a panel.

21. The apparatus of claim 20 additionally comprising a wheel cutter carried by the head for trimming tape segments after they are applied to the panel.

22. The apparatus of claim 20 wherein the controller segments the tape segments into first and second drawing layers based on membership in said first and second sets of tape segments.

23. The apparatus of claim 22 wherein the controller reformats the data from the drawing layers into control structures and transmits said structures to an additional controller coupled to the application head for controlling movement of the head in relation to the panel.

24. The apparatus of claim 20 wherein the controller moves the application head along controlled arcuate paths.

25. The apparatus of claim 21 wherein the tape supply includes a pliable elongated tape material which is separated into tape segments.

26. The apparatus of claim 25 wherein the tape material is a malleable metal material.
